(19) United States
(12) Patent Application Publication
(10) Pub. No.: US 2001/0004735 A1
(43) Pub. Date: Jun. 21, 2001

(54) Electronic commerce system and method

(75) Inventors: Toshiki Kindo, Yokohamai-shi (JP); Takehiko Shida, Yokohama-shi (JP); Hideyuki Yoshida, Sagamihara-shi (JP)

Correspondence Address: GREENBLUM & BERNSTEIN, 1941 ROLAND CLARKE PLACE, RESTON, VA, 20191

(73) Assignee: MATSUSHITA ELECTRIC INDUSTRIAL CO., LTD.

(21) Appl. No.: 09/738,771

(22) Filed: Dec. 18, 2000

(30) Foreign Application Priority Data
Dec. 21, 1999 (JP) 11-362521

(51) Int. Cl. G06F 17/60

(52) U.S. Cl. 705/37; 705/26

(57) ABSTRACT

The electronic commerce system enables a seller to register items composing a product in a combination of the items with an item database, further enables a coordinator to coordinate the combination of the items based on registered items, and stores the combination of items in a coordinate database. Meanwhile, the system opens the coordinate database to the public for a consumer to receive an order of an item from the consumer, and clears up payments of the charge from an account of the consumer to the seller when the transaction is completed.

### BACKGROUND OF THE INVENTION

1. Field of the Invention

The present invention relates to an electronic commerce system utilizing information communication networks using electronic, radio and/or optical system as media, and more particularly, to an electronic commerce system for presenting combinations of items matching with consumer preferences to sell.

2. Description of the Related Art

Recently, with the progress of the infrastructure regarding information techniques and information communication networks such as the internet, the electronic commerce (hereinafter referred to as e-commerce) utilizing the information communication networks has been expanded for various products.

Meanwhile, some products among products actually dealt exhibit a newly added value in a combination of a plurality of the products. In the specification of the present invention, each product is called “item” which is a component of such products that exhibit the newly added value by being combined with other products. For example, fashion goods and furniture is often sold on the assumption that a plurality of items is combined. A combination of an item with other items is capable of motivating a consumer to purchase the item. That is, in some products such as the fashion goods and furnishes, how to combine the products often has a specific value.

However, the e-commerce that only presents each item has not sufficiently coped with sales of items exhibiting specific characteristics and various values in a combination thereof such as fashion goods.

For example, when a consumer wants to purchase pants well-matching with a newly found wonderful sweater, in the conventional store sales, the consumer searches a range limited to items displayed in a store for an item satisfying her/his requirements, while trying on the items displayed in the store.

However, in the e-commerce system characterized by having various products, a consumer needs to find a desired item from a list having a huge number of items. Further, it is not easy for an information terminal used in the e-commerce to present to the consumer elements such as colors and touch of clothes despite such elements being important in choosing an item. Therefore, it is difficult for the consumer to choose an item really satisfying her/his requirements.

There is thus a problem that the conventional e-commerce system is not able to sufficiently deal with items of which a combination is important as well as consumer preferences such as fashion goods.

Further, there is considered a method for presenting to consumers a database of combinations of items formed by experts. However, the items in which individual preferences are important such as fashion goods have a low possibility that a preference of a consumer matches only to a specific expert. It is rather usual for a consumer to buy a casual wear at a store of an expert A and buy a sophisticated wear at another store of an expert B or C. Thus, the preference of a consumer is generally represented by a complicated combination of scenes and experts. Therefore, using only the database of combinations of items formed by experts is not able to achieve an e-commerce system satisfying requirements of consumers with respect to items of which a combination is important such as clothes. In the e-commerce system that is not able to cope with preferences of consumers sufficiently, there is a problem that a rate of returned items is not negligible in cost factor.

### SUMMARY OF THE INVENTION

It is an object of the present invention to provide an e-commerce system capable of presenting combinations of appropriate items matching with a preference of a consumer even when the consumer is not able to obtain sufficiently detailed information on the items, and thereby enabling a rate of returned items to be decreased.

That is, in the e-commerce system of the present invention, a seller registers items composing a product in a combination thereof with an item database. Based on registered items, a coordinator coordinates combinations of the items and stores the combinations of the items in a coordinate database. The coordinate database is opened to the public for consumers to make them to place orders, and after the transaction is completed, the payments from an account of a corresponding consumer and to the seller are performed. It is thereby possible to present combinations of items coordinated by coordinators with detailed knowledge, sophisticated sensitivity and high skills to consumers who do not have detailed knowledge on the registered items. Accordingly, choosing and purchasing an item from among the combinations is capable of highly satisfying consumer's shopping requirements. As a result, it is possible to decrease a rate of returned items. In addition, the coordinators are not limited to persons having sophisticated specific knowledge and skills, and it may be possible adequately for ordinary persons to join as the coordinators.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a block diagram of an e-commerce system according to one embodiment of the present invention;

FIG. 2 is a diagram illustrating an exemplary structure of a screen for use in registering coordinate data;

FIG. 3 is a diagram illustrating an exemplary structure of a learning and ordering screen displaying a list of model pictures;

FIG. 4 is a block diagram of an information filtering section of a virtual coordinator in the e-commerce system; and

FIG. 5 is a diagram illustrating an exemplary structure of an ordering screen for use in inputting ordering data.

### DETAILED DESCRIPTION OF THE PREFERRED EMBODIMENTS

An embodiment of an e-commerce system of the present invention will be described specifically below with reference to accompanying drawings. In addition, while this embodiment describes the e-commerce system dealing in fashion items, items subject to the present invention are not limited to fashion items.

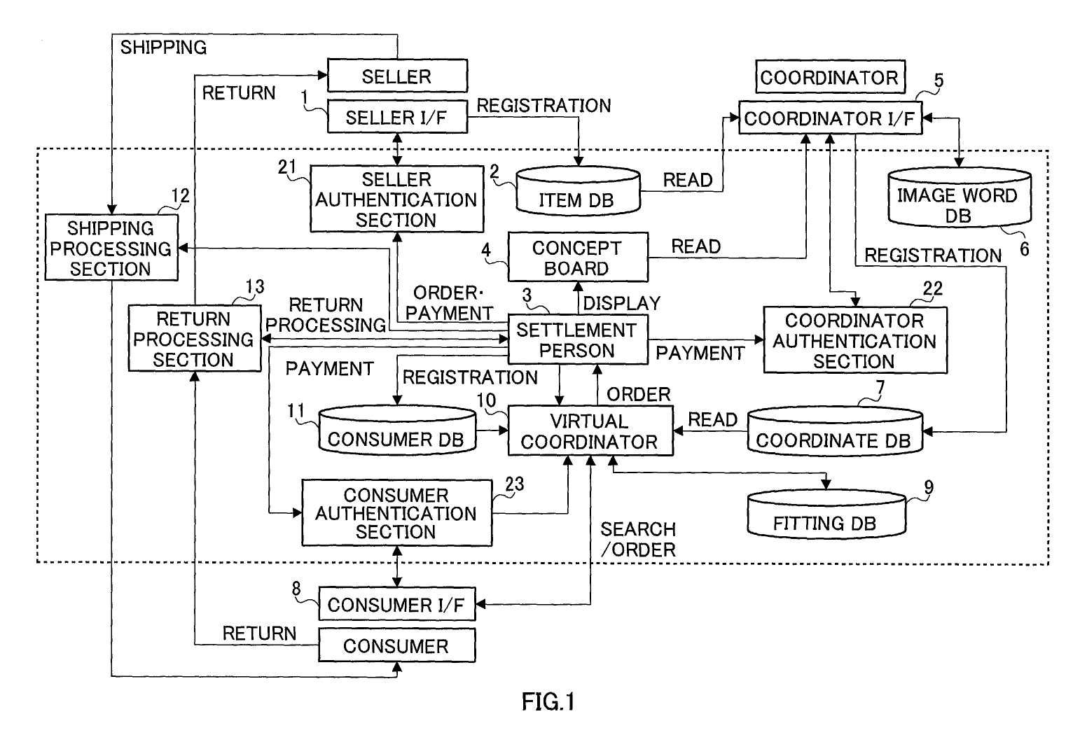

FIG. 1 is a block diagram of the e-commerce system according to this embodiment. A seller(s) that sells fashion items accesses to the e-commerce system via seller interface 1. Item data regarding items input by the seller via seller interface 1 is registered with item database 2. The items that the seller handles are stored in item database 2 as data of the database corresponding to characteristics of the items such as a color and touch.

Settlement person 3 who clears up the transaction of a fashion item displays concepts to coordinate fashion items (hereinafter referred to as coordinate concept) on concept board 4. In addition, a person who displays the coordinate concept on concept board 4 is not limited to settlement person 3, and it may be possible to receive any concept from any person such as a consumer, coordinator or seller to display.

The coordinator reads necessary information from item database 2 and concept board 4 to coordinate the items. The coordinator accesses to the item database 2 and concept board 4 using coordinator interface 5. Keywords to represent an image of a combination of items coordinated by the coordinate are stored in image-word database 6, and combinations of items are stored in coordinate database 7.

A consumer who purchases a fashion item accesses to the e-commerce system via consumer interface 8. The consumer inputs data needed for fitting of the fashion item such as height of the consumer via consumer interface 8, and the data is stored in fitting database 9. At least one virtual coordinator 10 is assigned to the consumer. Virtual coordinator 10 retrieves combinations of items from coordinate database 7 according to requirements of the consumer. Then virtual coordinator 10 places an order with settlement person 3 for the item that the consumer purchases. The orders for items from settlement person 3 to the seller are stored in consumer database 11 for each consumer. The item shipped from the seller receiving the corresponding order is sent to the consumer via shipping processing section 12 under control of the e-commerce system. Shipping processing section 12 requires processing corresponding to the shipping from settlement person 3.

Meanwhile, the consumer receives an ordered and set actual item and may return the item when it does not interest the consumer. The returned item is sent to the seller via return processing section 13 under control of the e-commerce system. Return processing section 13 requires processing corresponding to a returned item from settlement person 3.

Seller authentication section 21 provides functions of seller authentication and of communications with an account of the seller and the like. Further, coordinator authentication section 22 provides functions of coordinator authentication and of communications with an account of the coordinator and the like. Furthermore, consumer authentication section 23 provides functions of consumer authentication and of communications with an account of the consumer and the like.

In addition, the e-commerce system as described above is constructed with computers or a computer system. Further, seller interface 1, coordinator interface 5 and consumer interface 8 are each constructed with a computer which has installed browsing software such as an internet browser and which is accessible to the e-commerce system via information communication networks.

Moreover, it may be possible to open item database 2 and concept board 4 to the public on a web server to enable anyone to register an item and/or concept after registering the authentication with the e-commerce system in the first place.

In this case, it is possible to receive offers of items from manufactures all over the world as well as specific sellers, thereby expanding a range of coordination. Further, a coordinator is able to provide item combinations coordinated according to own concept. Meanwhile, a consumer is able to receive presentations of the item combinations in accordance with concepts matching with the consumer's preference from coordinators. Furthermore, a seller is able to propose the coordination with concepts obtained with items that the seller sells.

The operation of the e-commerce system constructed as described above is explained below. A seller accesses to seller authentication section 21 via seller interface 1. The seller performs registration processing with the e-commerce system when necessary, and is provided with the authentication to access to the system. The seller allowed to access registers item data in which items (cloths) that the seller wants to sell are described with item database 2 via seller interface 1. Preferable item data includes a picture, type such as a jacket, straight pants or long skirt, color, material such as cotton or wool, yarn size, weave, maker's name, and price of the item. A homepage managed by the e-commerce system on the internet provides the registration service for registering the item data with item database 2. The items registered with item database 2 are assigned respective item identification numbers.

Settlement person 3 displays a plurality of coordinate concepts to coordinate fashion on concept board 4. For example, settlement person 3 displays an concept having contents indicative of “casual dress vivid in winter scenery” on concept board 4.

A coordinator accesses to coordinator authentication section 22 via coordinator interface 5. Then, the coordinator performs registration processing with the e-commerce system when necessary, and is provided with the authentication to access to the system. Further, the coordinator reads the coordinate concepts displayed on concept board 4 via coordinator interface 5. Then, the coordinator reads item data suitable for the concepts from item database 2, and coordinates the items such as a jacket and pants according to own taste of the coordinator. It is preferable to enable the coordinator to operate for coordination using only a portion of item data (for example, picture of an item). After finishing the combination of items, the coordinator selects “keyword(s)” representing an image of the combination of items from image-word database 6. Then, the coordinator registers the combination of items as well as the keywords with the coordinate database 7 as coordinate data. Preferable coordinate data includes registered date, picture of a model with the items combined by the coordinator (hereinafter referred to as model picture), coordinator identification name, keyword(s), coordinate concept and item data. In addition, computer graphics is available as the model picture. It is further preferable to enable the coordinator to add new “keyword(s)” to image-word database 6.

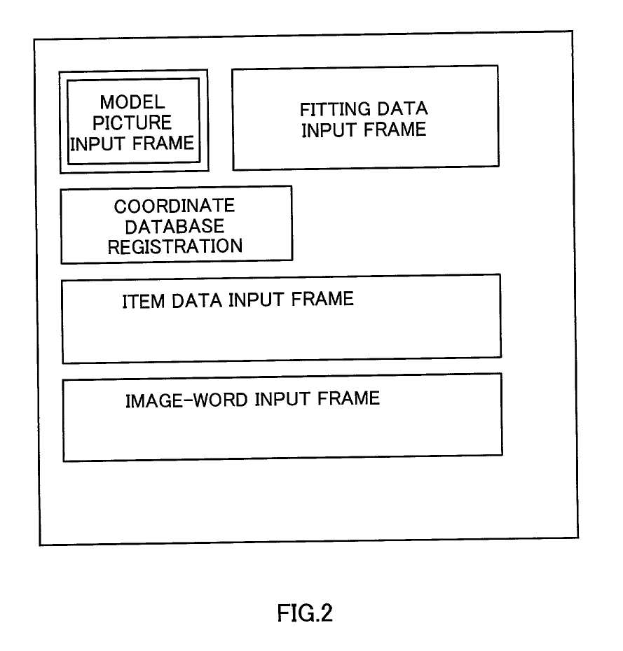

FIG. 2 is an exemplary structure of a registration screen for use by the coordinator in registering the coordinate data with coordinate database 7. The registration screen is composed of a model picture input frame, image-word input frame, item data input frame, fitting data input frame and coordinate database registering button. The registration screen is formed of a structured document with HTML, and is transferred to coordinator interface 5 by accessing to concept board 4 and clicking a desired coordinate concept. The coordinate database registering button is linked with a registration execution file for executing processing for registering the coordinate data with coordinate database 7.

When the coordinate database registering button is clicked, data input to each input frame, coordinator identification name and coordinate concept identification number are transferred to the e-commerce system from coordinator interface 5 with HTTP (Hyper Text Transfer Protocol) as well as a coordinate registration request.

Repeating the above procedures stores a plurality of coordinate data in coordinate database 7. It is preferable in this embodiment to arrange the plurality of coordinator data for each coordinate concept displayed on concept board 4.

A consumer who wants to purchase a fashion item first accesses to consumer authentication section 23 using consumer interface 8 via information communication networks. Then, the consumer performs registration procedure to be a purchaser. In the preferable registration procedure, whether or not the consumer is allowed to register is judged using information indicative of reliability of the consumer obtained by employing, for example, a credit card number and account number of the consumer, and then the registration procedure is performed for the consumer to be the purchaser. In addition, it may be possible to perform the registration procedure of a consumer at the time the consumer purchases an item.

When the registration for the consumer to be the purchaser is allowed, consumer authentication section 23 assigns at least one virtual coordinator 10 to the consumer. It may be possible to assign a plurality of virtual coordinators 10 for other people as well as the consumer such as a child, and husband/wife thereof corresponding to a request. Selection criterions are absolutely different between a case that the consumer purchases her/his own goods and another case that the consumer purchases goods for other people (child, husband/wife). As described later, since virtual coordinators 10 present ordered combinations of items suitable for individual taste, it is necessary to coordinate virtually according to individual taste and preference.

Virtual coordinator 10 accesses to coordinate database 7 to read the coordinate data. Then, virtual coordinator 10 presents coordinate concepts of which the number is appropriate for consumer interface 8 being used by the consumer.

The consumer selects a coordinate concept that the consumer requires among the coordinate concepts displayed on consumer interface 8. When the consumer selects the coordinate concept, virtual coordinator 10 selects coordinate data associated with the consumer selected coordinate concept among the coordinate data stored in coordinate database 7. Then, the virtual coordinator 10 transmits the learning and ordering screen composed of a list of model pictures contained in the selected coordinate data to consumer interface 8. When the number of model pictures is large, the learning and ordering screen is composed of a plurality of pages.

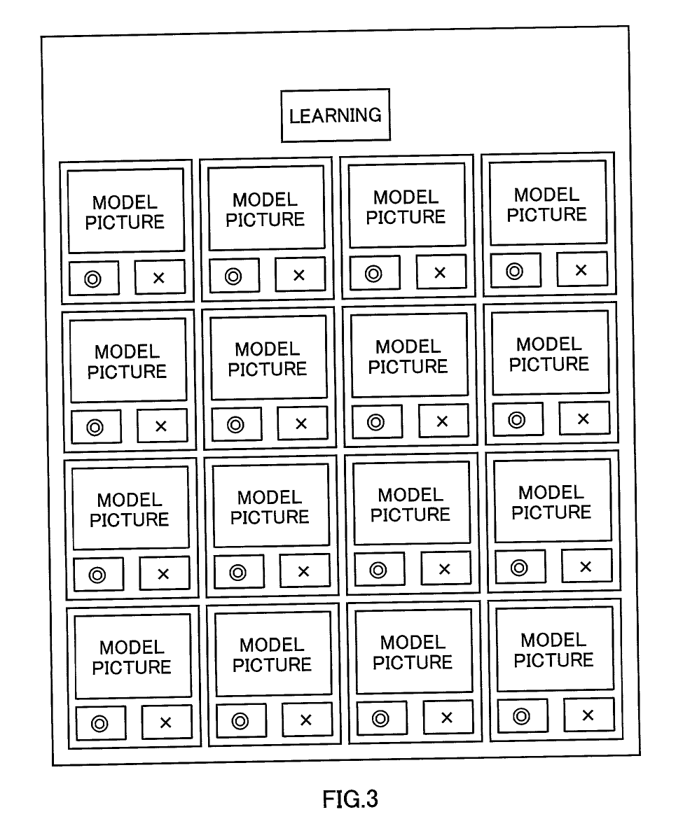

FIG. 3 is an exemplary structure of the learning and ordering screen displayed on consumer interface 8. As illustrated in FIG. 3, the learning and ordering screen is comprised of a plurality of model pictures, buttons (shown with “⊚” and “X”) for use in inputting whether or not a consumer is interested in respective pictures and learning buttons. It is preferable to present prices (sum of total cost of items, coordinate fee, expenses and benefit) on the learning and ordering screen. Further, it is preferable to display to a consumer just registered whose preference is not recognized at least one model picture for each coordinator who registers coordinate data. Combinations of items proposed by each coordinator depend on the taste of the coordinator. There is a strong tendency that a consumer purchases goods of a coordinator whose taste the consumer favors. Meanwhile, there is a limitation on model pictures for each of which a consumer inputs whether or not the picture interests the consumer on the learning and ordering screen. Accordingly, at the stage of learning, displaying model pictures proposed by as many coordinators as possible on the learning and ordering screen is extremely important from a point of view of accurately gasping the preference and taste of a consumer.

The consumer watches model pictures displayed on consumer interface 8, and inputs whether or not each of the pictures matches with her/his preference using a respective button. Based on each model picture, i.e., each coordinate data and an input indicative of the preference of the consumer, virtual coordinator 10 learns a tendency of the preference of the consumer. It is preferable that the learning is performed when a consumer presses a learning button.

When the learning button is pressed, virtual coordinator 10 rearranges and displays again the model pictures in descending order of consumer's interest according to information filtering described later with respect to coordinate data groups of the coordinate concept that the consumer selects.

The information filtering is explained herein according to which model pictures are rearranged in descending order of consumer's interest. The relationship is acquired between a coordinator identification name, keyword(s) and item data assigned to each coordinate data, and preference of a consumer. Then, how degree the consumer is interested in each coordinate data stored in coordinate database 7 is predicted with a necessity signal having a numerical value. It is thereby possible to represent the preference of the consumer with “AND” of a plurality of coordinator identification names and keywords, “AND” of a plurality of coordinator identification names and item data, and further combinations thereof, enabling the preference of the consumer to be precisely represented.

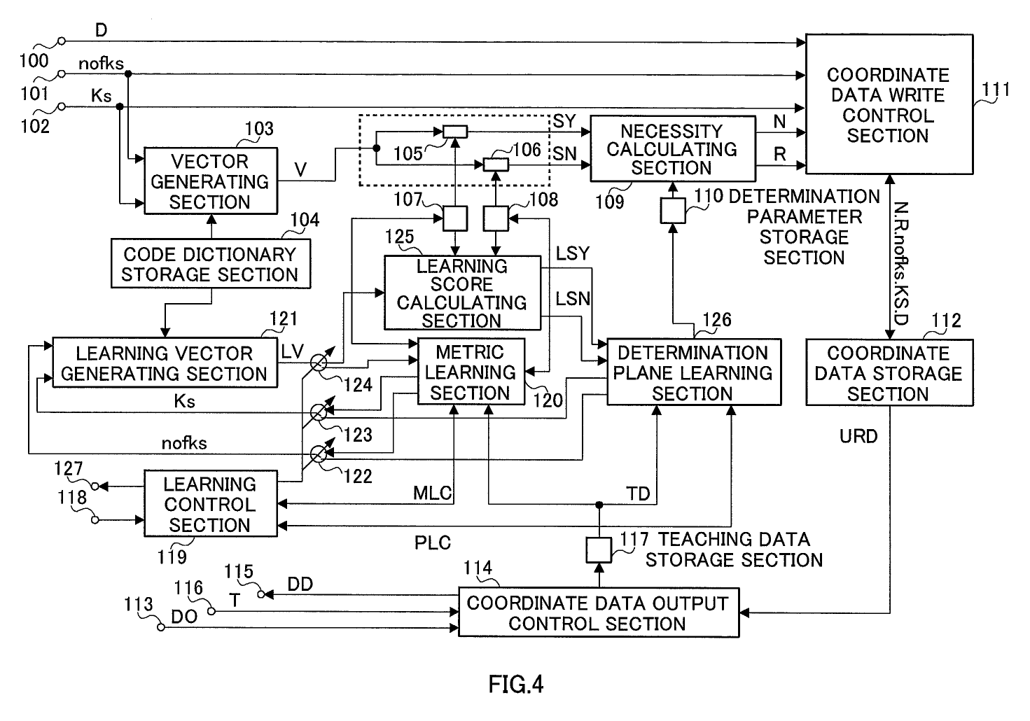

FIG. 4 is a block diagram of sections associated with the information filtering of virtual coordinator 10. A model picture of coordinate data to be evaluated is input to information data input terminal 100. Further, a number-of-keyword signal indicative of the number of keywords contained in the above coordinate data is input to number-of-keyword signal input terminal 101. Furthermore, a keyword group signal composed of a plurality of keywords is input to keyword signal input terminal 102. The keyword group signal is comprised of image keywords, item data and coordinator identification name of the model picture contained in the coordinate data.

Vector generating section 103 transforms from keyword group signal, character sequences, to a vector signal V. In order to transform the character sequences to the vector signal V, a character sequence is employed of a code dictionary signal stored in code dictionary storage section 104. Code dictionary storage section 104 stores character sequences of a plurality of coordinator identification names, image keywords, item data and the like each in a form of the code dictionary signal. When the same character sequence as a character sequence of a jth code dictionary signal is detected from the keyword group signal, “1” is input to a jth vector component of the vector signal V. When the same character sequence as the character sequence of the jth code dictionary signal is not detected, “0” is input to the jth vector component of the vector signal V. Similar processing is repeated with respect to all the components of the vector signal V.

Positive signal calculating section 105 calculates, using a positive metric signal, a positive signal SY such that a value thereof is large when the keyword group signal contains a large number of keywords that interested the consumer which the consumer previously replied. Negative signal calculating section 106 calculates, using a negative metric signal, a negative signal SN such that a value thereof is large when the keyword group signal contains a large number of keywords that did not interest or disliked the consumer which the consumer previously replied. The positive metric signal stored in positive metric storage section 107 is determined based on the keyword group signal and a result of reply that the consumer has an interest. The negative metric signal stored in negative metric storage section 108 is determined based on the keyword group signal and a result of reply that the consumer has no interest or dislikes.

Using the positive signal SY and negative signal SN, necessity calculating section 109 calculates a necessity signal N according to an equation of N=SY−C·SN and further calculates a reliability signal R according to another equation of R=C·SY+SN. The necessity signal N has a large value when there are a large number of keywords contained in the coordinate data (model picture) that interested the consumer which the consumer replied previously, and there are few keywords contained in the coordinate data (model picture) that did not interest the consumer which the consumer replied previously. The coefficient C is used to separate model pictures that the consumer is interested in and model pictures that the consumer is not interested in. The coefficient C is stored in determination parameter storage section 110.

Coordinate data write control section 111 decides the order of evaluated coordinate data and writes the ordered coordinate data in coordinate data storage section 112. Coordinate data storage section 112 stores the coordinate data arranged in descending order of necessity signal value.

At a stage that the learning is not performed, since the necessity signal N and reliability signal R are not calculated, a plurality of coordinate data contained in the coordinate concept designated by the consumer is written in coordinate data storage section 112 without deciding the order. The learning and ordering screen illustrated in FIG. 3 is generated using model pictures of the plurality of coordinate data written in the section 112. It is preferable to generate the learning and ordering screen with a structured document using HTML. The learning buttons are linked with a learning execution file. When the learning button is clicked, the consumer input data indicative of whether or not the model picture interests the consumer is collected and transferred to the learning execution file of virtual coordinator 10 as well as a learning request.

After the coordinate data is written in coordinate data storage section 112, a signal for instructing to start virtual coordinate is input to coordinate data output control section 114 via virtual coordinate start signal input terminal 113.

Coordinate data output control section 114 generates the learning and ordering screen using the model pictures of the coordinate data. Then, the section 114 transfers the learning and ordering screen from coordinate data output terminal 115 to consumer interface 8 of the consumer via information communication networks. It may be possible to use HTTP to transfer the structured document of the learning and ordering screen from the e-commerce system to consumer interface 8.

The structured document of the learning and ordering screen in FIG. 3 is displayed on a display of consumer interface 8. A consumer clicks a button of interest or dislike in each model picture to input a reply for the picture on consumer interface 8. When the learning button is clicked, data (hereinafter referred to as learning signal) indicative of interest or dislike in the model picture replied by the consumer and the learning request are returned to virtual coordinator 10 via information communication networks. The leaning execution file is thereby started up. The learning execution file manages learning processing described later.

When virtual coordinator 10 receives the learning request transmitted from consumer interface 8, the coordinator 10 fetches a teaching signal T transmitted along with the learning request. The teaching signal for each model picture displayed on the learning and ordering screen is stored in teaching data storage section 117 via coordinate data output control section 114. Each teaching signal T is stored with a keyword group signal and number-of-keyword signal each corresponding to the signal T in teaching data storage section 117.

After the data necessary for the learning is stored in teaching data storage section 117, a learning start signal is input to learning start signal input terminal 118. When the learning start signal is input, learning control section 119 turns on switches 122, 123 and 124 to connect metric learning section 120 and learning vector generating section 121.

Metric learning section 120 fetches the teaching signal T, keyword group signal and number-of-keyword signal from teaching data storage section 117, and inputs the keyword group signal and number-of-keyword signal to learning vector generating section 121. Learning vector generating section 121 transforms the keyword group signal to a learning vector signal LV using the code dictionary signal as well as vector generating section 103. The positive metric signal is corrected based on the learning vector signal LV corresponding to the teaching signal T indicative of interest. Meanwhile, the negative metric signal is corrected based on the learning vector signal LV corresponding to the teaching signal T indicative of dislike.

The positive metric signal thereby has a large value with respect to the keywords (coordinator identification name, item data, image keyword and so on) included in the coordination (model picture) that interests the consumer. Similarly, the negative metric signal thereby has a large value with respect to the keywords (coordinator identification name, item data, image keyword and so on) included in the coordination (model picture) that does not interest or dislikes the consumer.

Learning score calculating section 125 operates in a similar way to positive signal calculating section 105 (negative signal calculating section 106), and thereby calculates a learning positive signal LSY and a learning negative signal LSN from the learning vector signal LV. Using the learning positive signal LSY and learning negative signal LSN, determination plane learning section 126 obtains the coefficient C that most accurately separates model pictures that interest the consumer and model pictures that do not interest the consumer. The coefficient C is expressed on a two-dimensional space using the positive signal SY and negative signal SN. The obtained coefficient C is stored in determination parameter storage section 110. When the learning is finished, learning control section 119 outputs a learning finish signal from learning finish signal output terminal 127.

After confirming that the learning finish signal is output, coordinate data write control section 111 inputs again each model picture, and the keyword group signal and number-of-keyword signal each assigned to the model picture stored in coordinate data storage section 112 to respective input terminals 100, 101 and 102. As a result, with respect to each model picture, the necessity signal is calculated which accurately reflecting interests (preference and taste) of the consumer based on the keywords assigned to the model picture. The model pictures are rearranged in descending order of the necessity signal, and the ordered pictures are stored again in coordinate data storage section 112. Coordinate data output control section 114 fetches models picture from the coordinator data rearranged in descending order of the necessity signal, and generates the learning and ordering screen with the model pictures rearranged in descending order of the necessity signal. The section 114 transfers the generated screen to consumer interface 8 to display again.

The consumer looks at the rearranged model pictures, and retrieves a model picture (combination of items) matching with the consumer's preference. In addition, the consumer inputs the preference again when necessary. Repeating the processing, i.e., only putting whether or not the picture matches with the consumer's preference enables the consumer to obtain a combination of fashion items matching with the consumer's preference.

In addition, it is also possible to rearrange the coordinate data using the above-mentioned information filtering to display when the consumer changes the coordinate concept during the retrieval.

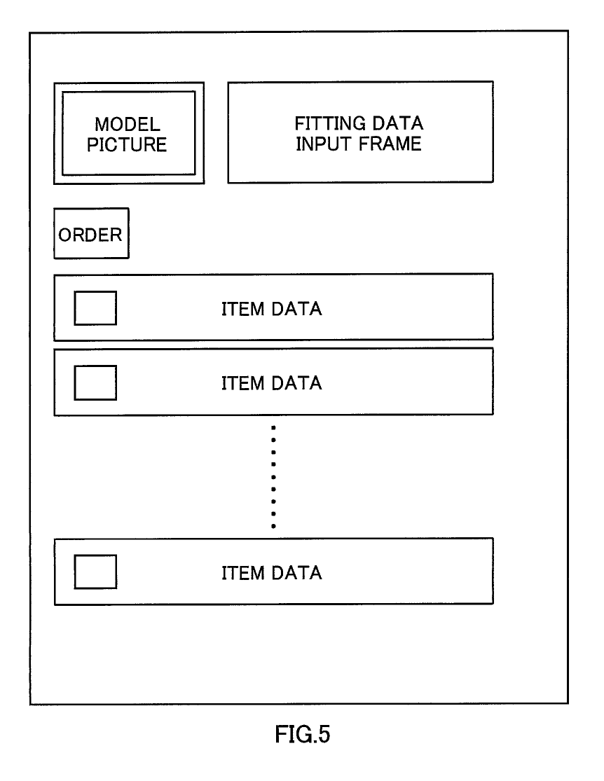

When the consumer finds out the combination of fashion items matching with the consumer's preference, she/he places an order for the combination of items. In the e-commerce system, when the model picture corresponding to the combination is clicked, an ordering screen as illustrated in FIG. 5 is displayed on the consumer interface. Displayed at upper left of the ordering screen illustrated in FIG. 5 is the model picture of the selected coordinate data. Further displayed at upper right is the fitting data input frame for use in inputting data necessary for choosing a size of a cloth such as height of the consumer. Furthermore, under the fitting data input frame is a frame for displaying a list of the items contained in the selected coordinate data. In the list, a check button is provided for each item to designate an item for which the order is placed. The consumer selects one or more required items with the check buttons, and presses an ordering button.

In addition, it is preferable to provide the list at its beginning with a field of “set of coordination” for use in placing an order for all the items one time. In this case, it is possible to place an order for the combination of coordinated items collectively, thereby enabling simplified ordering processing.

After confirming that the ordering button is pressed, virtual coordinator 10 sends ordering data to settlement person 3, and then writes the fitting data in fitting database 9.

Settlement person 3 checks a payment ability of the consumer, for example, using a credit card of the consumer. Then, the person 3 sends an item ordering request and an item identification number to the seller via seller authentication section 21, while sending data of the consumer and the item identification number to shipping processing section 12.

When the seller receives the item ordering request, the seller sends the item to shipping processing section 12 of the e-commerce system.

When shipping processing section 12 receives the item, the section 12 searches item identification numbers stored therein for an item identification number according with that attached to the item. Then, the section 12 reads the data of the consumer that places an order for the item designated with the item identification number, and ships the item to the consumer. At this point, the section 12 sends the item identification number and the data of the consumer to return processing section 13.

The consumer receives the item. When the consumer wants to return the item, she/he returns the item to the e-commerce system within a predetermined period.

When return processing section 13 does not receive a returned item attached the item identification number in the predetermined period starting from the time of receiving the item identification number from shipping processing section 13, the section 13 transmits a signal indicative of the item identification number and of that the item is not returned to settlement person 3.

Settlement person 3 who receives the signal indicative of the item identification number and of that the item is not returned performs a procedure for settling a payment of the corresponding item via consumer authentication section 23. Then, settlement person 3 pays the charge to the seller who sells the ordered item, while paying the coordinate charge to the coordinator who generates the coordinate data used in the order. Further, settlement person 3 stores data concerning the item in consumer database 11.

When return processing section 13 receives the returned item attached the item identification number in the predetermined period starting from the time of receiving the item identification number from shipping processing section 12, the section 13 returns the item to the seller, while transmitting a signal indicative of the item identification number and of that the item is returned to settlement person 3.

When settlement person 3 receives the signal indicative of the item identification number and of that the item is returned, the person 3 transmits a signal indicative of that the item is returned and of coordinate data indicating the combination of items to virtual coordinator 10 of the consumer.

The consumer returning the item is indicative of that the returned item, which is judged to match with the preference of the consumer at the time of placing its order, actually does not match with the preference of the consumer. Therefore, virtual coordinator 10 rewrites data indicative of the preference of the consumer to be the same as the case that the consumer judges the item does not match with the preference with respect to the coordinate data. Then, virtual coordinator 10 stores return data concerning the item in consumer database 11.

Thus reflecting information on an item returned from a consumer enables an evaluation on the item actually shipped to be reflected. It is thereby possible to retrieve coordinate data matching with the preference of the consumer.

When the consumer uses virtual coordinator 10 at the second time and thereafter, virtual coordinator 10 preferentially presents to the consumer the coordinate data expected to match with the preference of the consumer using the information filtering with the preference of the consumer stored previously.

In the embodiment as described above, virtual coordinator 10 decides the order of a plurality of items of coordinate data contained in a coordinate concept designated by a consumer based on the reply of the consumer, however, it may be possible to present those in turn without deciding the order. Also in this case, it is possible for a consumer to select one from combinations coordinated by an expert (coordinator) having sufficiently detailed knowledge on items even without the order decided by virtual coordinator 10, whereby it is possible for the consumer to find out an appropriate combination of items matching with the preference and taste of the consumer among huge information even when the consumer is not able to obtain sufficiently detailed information on the items.

According to the present invention as described in detail above, it is possible to present appropriate combinations of items matching with the preference and taste of a consumer even when the consumer is not able to obtain sufficiently detailed information on the items, and as a result to provide an e-commerce system which achieves a decreased rate of returned items.

The present invention is not limited to the above described embodiments, and various variations and modifications may be possible without departing from the scope of the present invention.

This application is based on the Japanese Patent Application No. HEI11-362521 filed on Dec. 21, 1999, entire content of which is expressly incorporated by reference herein.

What is claimed is:

1. An electronic commerce system using an information communication network, comprising
an item database with which a seller registers items composing a product in a combination of the items to open to the public for a coordinator;
a coordinate database with which the coordinator registers combinations of items that the coordinator coordinates using the items registered with the item database; and
a settlement mechanism that opens the coordinate database to the public for a consumer to receive an order of an item from the consumer, while clearing up payments of a charge from an account of the consumer and to the seller when transaction is completed.

2. The electronic commerce system according to claim 1, further comprising:
at least one virtual coordinator which assists the consumer in searching the coordinate database according to a request from the consumer.

3. The electronic commerce system according to claim 2, wherein the virtual coordinator presents the combinations of items coordinated to the consumer, receives a response indicative of whether the consumer is interested in each presented combination of items, and based on the reply from the consumer, searches for a combination of items coordinated suitable for a preference of the consumer.

4. The electronic commerce system according to claim 3, wherein when an item is returned from the consumer who purchased the item, the virtual coordinator searches for a combination of items coordinated suitable for the preference of the consumer in which information on a returned item is reflected.

5. The electronic commerce system according to claim 1, wherein a concept board on which concepts of the coordinator are displayed is open to the public for the coordinator, and combinations of items coordinated according to the concepts are registered with the coordinate database for each concept.

6. The electronic commerce system according to claim 2, wherein the coordinate database stores coordinate data having combinations of items coordinated, and image-words and coordinator identification name, attached to respective combinations, which the coordinator assigns to each combination of items coordinated, and the virtual coordinator fetches item data, an image-word and the coordinator identification name contained in each combination of items coordinated as keywords, and searches for a combination of items suitable for a preference of the consumer corresponding to a degree of keywords being contained in the coordinate data replied from the consumer on whether the data interests the consumer.

7. The electronic commerce system according to claim 1, wherein the consumer is capable of placing an order for the commination of items coordinated collectively.

8. The electronic commerce system according to claim 1, wherein items to be coordinated are invited and open to the public on a web server.

9. The electronic commerce system according to claim 1, wherein concepts of coordination are invited and open to the public on a web server.

10. A seller terminal for use by a seller in registering items composing a product in a combination of the items, wherein the seller accesses to the electronic commerce system according to either of claims 1 to 9 via an information communication network to be authenticated to access to the system, and registers the items with the item database.

11. A consumer terminal for use by a consumer in searching for and placing an order for one or more items composing a product in a combination of the items, wherein the consumer accesses to the electronic commerce system according to either of claims 1 to 9 via an information communication network to register the consumer with the system to be a purchaser, receives a plurality of combinations of items coordinated which are presented from the electronic commerce system, and places an order for an item among the combinations of the items presented.

12. An electronic commerce method using an information communication network, comprising the steps of:
registering by a seller items composing a product in a combination of the items with an item database to open to the public for a coordinator;
registering by the coordinator combinations of items that the coordinator coordinates using the items registered with the item database with a coordinate database; and
opening the coordinate database to the public for a consumer to receive an order of an item from the consumer, while clearing up payments of a charge from an account of the consumer and to the seller when transaction is completed.
